(19) United States
(12) Patent Application Publication
(10) Pub. No.: US 2014/0075838 A1
(43) Pub. Date: Mar. 20, 2014

(54) Method for Determining an Amount to be Applied and Device for Carrying Out the Method

(71) Applicant: Bernhard Limbrunner, Otzing (DE)

(72) Inventor: Bernhard Limbrunner, Otzing (DE)

(73) Assignee: Georg Fritzmeier GmbH & Co. KG, Aying (DE)

(21) Appl. No.: 14/118,102

(22) PCT Filed: May 16, 2012
(86) PCT No.: PCT/EP2012/059211

§ 371 Date: Nov. 15, 2013

(30) Foreign Application Priority Data
May 18, 2011 (DE) 10 2011 050 460.5

(51) Int. Cl. A01G 1/00

(52) U.S. Cl. CPC A01G 1/001
USPC 47/58.1 R

(57) ABSTRACT

The invention relates to a method for dispensing an amount to be applied in which a characteristic, for example a linear characteristic, is predetermined from which an amount to be applied can be read in accordance with a development status. Said characteristic can be manually corrected by the user. According to the invention, the amount which is to be applied can be determined in accordance with the yield, potential.

### BACKGROUND OF THE INVENTION

1. Field of the Invention

The invention relates to a method for determining and dispensing an amount to be applied and a device for carrying out said method.

2. Description of Related Art

In farming, especially in the field of precision farming, it is one of the great challenges to specifically dispense operating supplies or active agents such as fungicides, herbicides, fertilizers etc. in subareas, wherein oversupply and undersupply should be avoided where possible. For example in the case of fertilizing, over-fertilization is a problem from both the ecological and the economic view. In the case of under-fertilization, the yield of the plot is reduced so that need-optimized fertilization has to be strived for.

Due to the heterogeneity of the soil and the microclimate, the yield capacity and the availability of nutrients from the soil are varying within one plot. Said heterogeneities result is different growth of the plants and, as a rule, in a differentiated yield formation and a correspondingly different requirement of fertilizer as well as a need of other operating material. At present, in fanning practice the amount of fertilizer is dispensed in a uniform dosage over the entire plot—said heterogeneities frequently are not taken into account. Such uniform fertilization results in more or less great oversupply or undersupply in individual subareas with the accompanying drawbacks. The same applies mutatis mutandis to the dispensing of other operating material such as fungicides, growth regulators etc.

A system for specific fertilization in subareas is known in which the nutrient state of a plant is detected via a sensor and then the fertilizer required is calculated in response to the sensor signal, for example a vegetation index and subarea-specific data which are available in the on-board computer. Based on the fertilizer required, a control signal for a fertilizer metering device (spreader) is then generated. Such solution is disclosed, for example, in DE 199 13 971 A1.

In these solutions the sensor has to be calibrated before start-up for calculating the amount of fertilizer based on a vegetation index. This can be performed, for example, by a so called N-tester which has a number of drawbacks, however. Such N-tester basically is only an aid. The use of an N-tester is extremely complicated and requires certain experience. The N-tester measures the transmission of light through the leaves of plants. This value is closely correlated with the chlorophyll content and the N content but not with the amount of biomass. The N absorption important to the rating of fertilizer is calculated based on the N content and the biomass. It is a problem in this context that the N absorption is determined more by the biomass of the plant than by the N content. As afore-mentioned, when rating the fertilizer with the described system the yield capacity of the site is not taken into account. This yield capacity influences the nutrient requirement more than variations of the N concentration in the plant, however. Usually plants in low-yielding subareas have a lower N requirement—in those subareas even small amounts of N are therefore sufficient for optimum growth due to other yield-restricting parameters so that those subareas are regularly over-fertilized when the yield capacity is not taken into account. High-yielding subareas, on the other hand, tend to be insufficiently provided with fertilizer.

Moreover, the measured value of the described sensor is strongly dependent on the variety, which is why so called variety correction tables are also supplied. Since, however, each year a plurality of varieties is admitted by the Federal Office for Plant Varieties, accordingly said variety correction tables have to be annually updated, which further impedes the handling of the sensor.

By the brand ISARIA® applicant offers for winter wheat an absolute calibration and a fertilizing system taking the yield potential into account. However, said fertilizing systems can be used in other crop varieties under reserve only.

### SUMMARY OF THE INVENTION

Compared to this, the object underlying the invention is to provide a method for determining or for dispensing an amount to be applied and a device for carrying out the method by which a need-based application of operating supplies is facilitated.

This object is achieved with respect to the method by the features of claim I and with respect to the device by the features of claim 6.

Advantageous further developments of the invention form the subject matter of the subclaims.

A basic version of the method for determining and dispensing an amount to be applied is as follows:
single-point calibration of the system: the farmer covers a particular distance at any location in the plot (manual start and stop of calibration), establishes a vegetation index there by means of an appropriate sensor and allocates an amount to be applied, for example an amount of fertilizer (in kg N/ha), to this location (to the established measured value).
As standard gradient of the control curve including this pair of values (comparative index and allocated amount to be applied) an initial gradient is determined (during fertilizing e.g. −6 (i.e. −6 kg N/ha for each variation of measured value), this is the gradient of EC32 with a yield level of 8.5 t/ha). The value of the gradient is displayed on the working screen.
The fanner then starts application, for example fertilizing with the predetermined gradient. If the sensor or the device performs too lithe or too much control of the amount to be dispensed, the farmer can increase or reduce the gradient—for instance by 1 at a time by a +/− key on the working screen. Thus he/she varies the gradient of the variation of measured value per unit by 1 at a time (i.e. the gradient becomes steeper or flatter). The gradient can be selected to be both positive (yield-oriented) and negative (homogenized). The characteristic still extends through the initially established pair of values.

The farmer can adjust known calibration settings already in advance so that no calibrating passage is required,

Furthermore the farmer has the possibility of increasing or reducing the amount to be applied by a +/− key (this corresponds to parallel displacement of the control curve).

In order to restrict the amount to be dispensed in the data memory, an upper limit and/or lower limit can be defined for the respective amount to be dispensed which cannot be exceeded or gone below.

The application system is now calibrated (single-point calibration).

Preferably for the order a yield potential map is deposited in a computer, for example in a tablet PC.

The farmer performs the afore-described “single-point calibration” at a particular location.

Due to the deposited yield potential map the yield potential of the location of calibration can be determined. −> With a corresponding yield potential then a measured value of xx corresponds to an amount to be applied, for example an amount of fertilizer of yy kg/ha.

If the sensor now gets into another yield zone, the calculated amount to be applied has to be settled with appropriate additions or deductions (corresponding to a parallel displacement of the control curve) so as to perform an adaptation to the other yield potential read out of the yield potential map. Said additions and deductions can be directly predetermined by the farmer.

Then the amount to be applied is read out of the calibrated characteristic in response to the vegetation index detected by the sensor and is dispensed via a metering device or the like.

The device according to the invention includes a sensor by which for example a vegetation index which is intimately connected with the growth state can be detected. The device is further designed so that the amount to be applied (the fertilizer required or the amount of fertilizer to be dispensed) can be read out of a data memory in response to the growth state indirectly or directly detected by the sensor, for example a nutrient state, with the aid of the characteristic defined in single-point calibration.

Moreover, the device is configured to have a correcting means that allows manual variation of the gradient author of the course, especially a parallel displacement of the characteristic defined in single-point calibration so as to avoid over-regulation or under-regulation of the dispensed amount to be applied.

The control range can be additionally restricted by defining an upper limit or lower limit for the amount to be applied.

The device according to the invention thus permits calibration of the sensor system or dispense of an amount to be applied dependent on empirical values with a minimum effort in terms of software and hardware.

Such device can be combined with an application device for dispensing the amount to be applied, for instance the amount of fertilizer, which was determined in accordance with the method according to the invention.

The afore-outlined single-point calibration can be carried out within extremely short time. The afore-described single-point calibration preferably is carried out only in one yield potential zone, wherein in other zones the characteristics then are determined by additions or deductions, i.e. by a parallel displacement of the characteristic resulting from the single-point calibration.

These and other features and advantages of the invention will become apparent to those skilled in the art from the following description and the accompanying drawing. It should be understood, however, that the detailed description and specific examples, while indicating a preferred embodiment of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

FIG. 1 illustrates a characteristic used in the method according to the invention, wherein said characteristic shows the dependence of the amount to be applied on IRMI. IRMI is a vegetation index determined by applicant by the afore-described ISARIA system which is very closely connected with the growth state of crops. In the shown embodiment a linear characteristic is used, however basically also other types of characteristic can be taken as a basis, wherein a respective adaptation is then carried out by the farmer.

FIG. 2 is a flow chart illustrating a preferred embodiment of the invention.

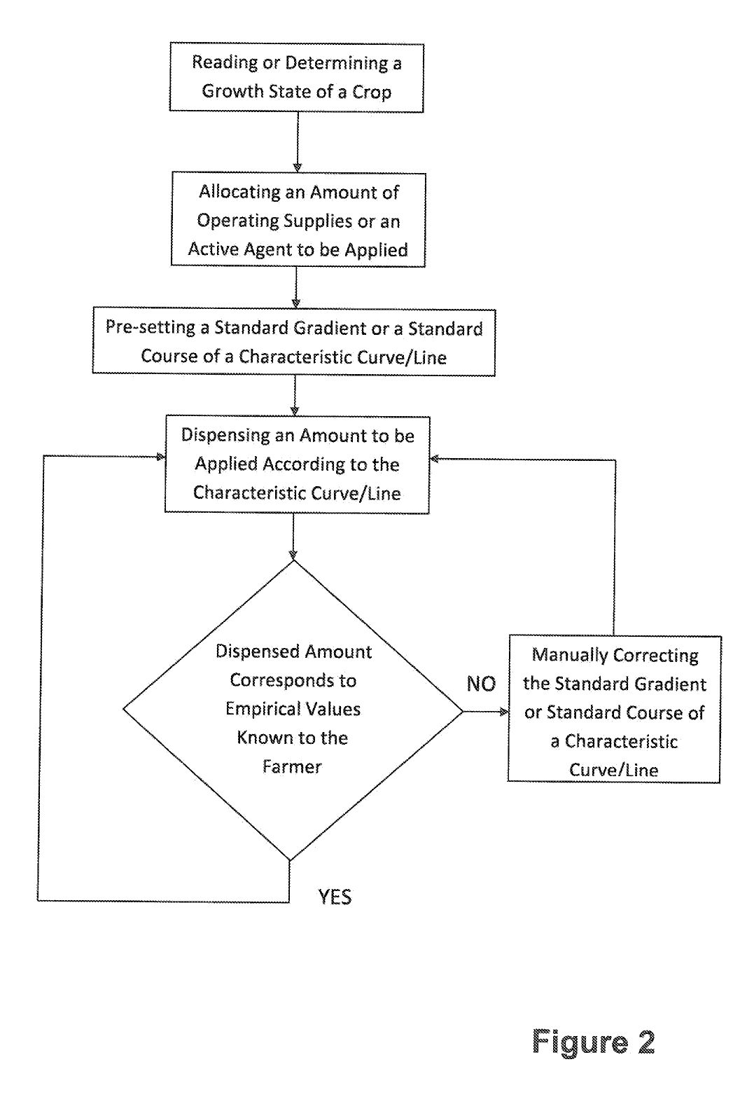

### DETAILED DESCRIPTION OF THE PREFERRED EMBODIMENT

The method according to the invention shall be illustrated hereinafter by way of an embodiment in which fertilizer is to be dispensed as application. On principle, the same method can also be used for applying other operating supplies, for example fungicides, growth regulators, siccation agents.

According to the foregoing remarks, at first the fanner is heading for a particular location on the plot and by means of the sensor there determines the growth state, viz. during fertilizing the nutrient state. In the described embodiment the vegetation index “IRMI” is used. As a matter of course, also other indices can be used to characterize the nutrient state. in the shown embodiment a growth state (vegetation index) of “24.5” is measured by the sensor. Then the fanner allocates a predetermined amount to be applied (amount of fertilizer) to this measured value, in the shown embodiment somewhat more than 65 kg/ha. Depending on the application, the amount to be applied can also be expressed as l/ha. As afore-explained, a linear characteristic having a predetermined gradient extending through this pair of values (growth state, amount to be applied) is assumed. With this predetermined gradient and the calibration of the characteristic, for instance at a growth state of “20” an amount to be applied of equally 20 kg/ha is resulting.

As explained already in the beginning, for restricting the control range a lower limit and an upper limit can be predetermined, wherein in the shown embodiment the lower limit is an amount to be applied of 40 kg/ha, while the upper limit is set to be 80 kg/ha, That is to say, the amount of application which is to be dispensed is restricted to this range between the lower limit and the upper limit. Accordingly, in this embodiment an amount to be applied of 40 kg/ha is constantly dispensed for values of the vegetation index IRMI of from 20 to 22. For IRMI values above 26 the amount to be applied constantly is 80 kg/ha. When restricting the control range by a lower limit and an upper limit, thus an approximately Z-shaped course of the characteristic with the parallel sections predetermined by the lower limit and the upper limit and the interposed inclined section defined by the gradient of the characteristic is resulting.

Without these upper limits and/or lower limits the characteristic continuously extends with a constant gradient. In the shown embodiment a linear characteristic/control curve is assumed. Basically also a different course can be taken as a basis, however, which then can be appropriately adapted in response to the empirical values of the user. On principle, also only a lower limit or only an upper limit can be predetermined.

After the afore-described single-point calibration the amount to be applied (amount of fertilizer) according to the method of the invention is then dispensed.

As a matter of course, also a vegetation index unlike the IRMI and/or a different sensor can be employed so as to determine the amount to be applied.

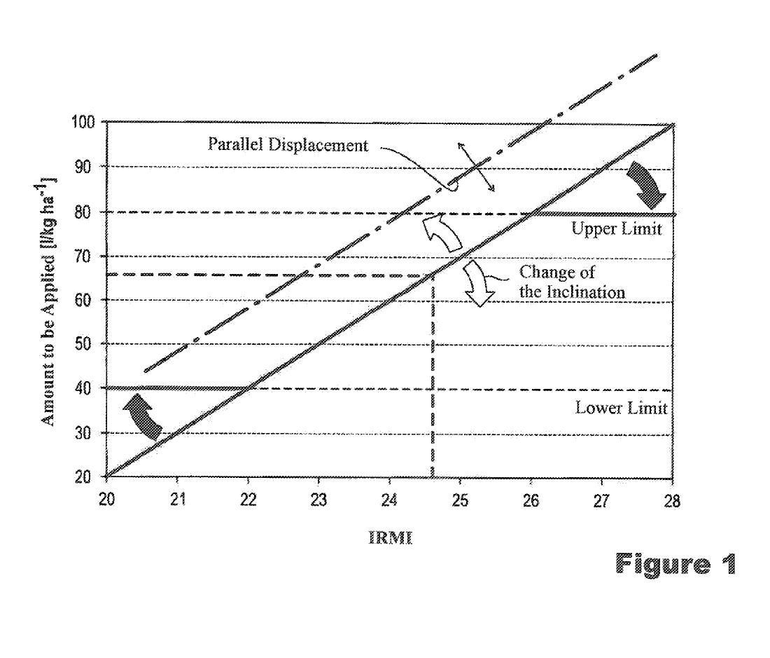

For adapting the dispensed amount to be applied, the farmer can change the gradient of the control curve on the basis of his/her experience (cf. FIG. 1). Alternatively or additionally the farmer can further increase or reduce the amount to be applied by the “key” provided on the hardware or software side of the device according to the invention, which results in a parallel displacement of the characteristic shown in FIG. 1 (cf. broken line in FIG. 1). In the illustrated embodiment a linear characteristic/control curve is assumed. On principle, also a different course can be taken as a basis.

As explained before, in the method according to the invention it is provided that the amount to be applied is dispensed also as a function of the yield potential of the plot. For this purpose, a yield potential map of the respective plot is stored in the memory (map overlay). The fanner then carries out the afore-described single-point calibration in a yield zone (partial plot). As soon as a different yield zone is reached which is identified due to the yield potential map stored in the memory, the amount to be applied calculated by means of the calibrated characteristic can be settled with additions or deductions in the afore-described manner—i.e. the characteristic then can be displaced in the manner shown in FIG. 1 as a function of the yield potential upwards in the direction of a larger amount to be applied or downwards in the direction of a smaller amount to be applied. The amount of additions and deductions is predetermined by the user.

The invention discloses a method for dispensing an amount to be applied in which a characteristic, for example a linear characteristic, is predetermined from which an amount to be applied can be read in accordance with a growth state. Said characteristic can be manually corrected by the user. According to the invention, the amount to be applied can be determined as a function of the yield potential.

In summary, a method for determining an amount of operating supplies or an active agent to be applied dependent on a detected growth state of a crop includes the following steps. Initially, a growth state in an area of a plot is read or determined. Then the method includes allocating an amount to be applied to said growth state. Thereafter, a standard gradient or a standard course of a characteristic including the afore-mentioned data for determining the amount to be applied dependent on the growth state is predetermined. Next, the method includes the step of dispensing the amount according to the preset gradient or course. According to the method, the farmer then manually corrects the gradient or the course of the characteristic curve or line if the dispensed amount does not correspond to empirical values known to him. Notably, the yield potential of the respective plot can be considered when determining the amount to be applied.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

1. A method for determining an amount of operating supplies or an active agent to be applied dependent on a detected growth state of a crop, comprising the steps of:
reading or determining a growth state in an area of a plot;
allocating an amount to be applied to said growth state;
presetting a standard gradient or a standard course of a characteristic curve including the afore-mentioned data for determining the amount to be applied dependent on the growth state;
dispensing the amount to be supplied according to the characteristic curve;
manually correcting the gradient or the course of the characteristic curve, if the dispensed amount does not correspond to empirical values known to the fanner; and
wherein the yield potential of the respective plot can be considered when determining the amount to be applied.

2. The method according to claim 1, wherein the growth state is detected for a specific subarea via a sensor.

3. The method according to claim 2, wherein the growth state is determined by means of a sensor detecting a vegetation index (IRMI).

4. The method according to claim 1, wherein an upper limit and/or a lower limit for the application amount to be dispensed which is not exceeded or gone below is stored in a data memory.

5. The method according to claim 1 comprising the step of
dispensing an amount to be applied by means of an application system read from the characteristic curve dependent on the growth state determined each time.

6. A device for carrying out the method according to claim 1, comprising a sensor for indirectly or directly detecting a nutrient state, comprising a data memory for storing a characteristic curve from which the application requirement can be read dependent on the growth state and comprising a correcting means for manually correcting the gradient or the course of the characteristic curve.

7. The device according to claim 6, wherein an upper limit and/or lower limit of the application amount to be dispensed is stored in the data memory.

8. The method or device according to claim 1, wherein fertilizer is dispensed as application and the growth state is the nutrient state.
